(19) United States
(12) Patent Application Publication
(10) Pub. No.: US 2012/0026182 A1
(43) Pub. Date: Feb. 2, 2012

(54) DISPLAY APPARATUS AND CONTROL METHOD OF THE SAME

(75) Inventor: Hyun-Jun RA, Seoul (KR)

(73) Assignee: Samsung Electronics Co., Ltd., Suwon-si (KR)

(21) Appl. No.: 13/088,818

(22) Filed: Apr. 18, 2011

(30) Foreign Application Priority Data
Jul. 30, 2010 (KR) 10-2010-0073788

(51) Int. Cl. G09G 5/02

(52) U.S. Cl. 345/589

(57) ABSTRACT

A display apparatus and a control method thereof, the display apparatus including a display unit to display thereon a two-dimensional (2D) image or a three-dimensional (3D) image, a brightness adjuster to adjust a brightness of an image that is displayed on the display unit, and a controller to control the brightness adjuster to change a maximum brightness of the display unit depending on whether the image displayed on the display unit is the 2D image or the 3D image.

### CROSS-REFERENCE TO RELATED APPLICATIONS

This application claims priority under 35 U.S.C. §119(a) from Korean Patent Application No. 10-2010-0073788, filed on Jul. 30, 2010 in the Korean Intellectual Property Office, the disclosure of which is incorporated herein in its entirety by reference.

### BACKGROUND

1. Field of the Invention

Apparatuses and methods consistent with the exemplary embodiments relate to a display apparatus and a control method of the same, and more particularly, to a display apparatus and a control method of the same which displays a two-dimensional image and a three-dimensional image.

2. Description of the Related Art

According to technological development, a display apparatus processes and displays various types of video signals, whether digital or analog. Recently, users may view a stereoscopic image as a three-dimensional (3D) image signal through a desktop computer, a notebook computer or a TV which is easily accessible. A content of a stereoscopic image signal should be divided according to a user's right eye and left eye unlike a two-dimensional (2D) image signal, and the divided image should be displayed for user's left and right eyes.

If a 3D image is displayed, such 3D image requires brightness two times or more compared to a 2D image. If a 2D image is displayed following a 3D image, a brightness is too high and a user may feel inconvenient in using the display apparatus and a power loss may occur.

### SUMMARY

Accordingly, exemplary embodiments provide a display apparatus and a control method of the same which automatically controls different maximum brightness depending on a type of an image and reduces a power consumption.

Also, exemplary embodiments may also provide a display apparatus and a control method of the same which sets a maximum brightness depending on a type of an image.

Additional features and utilities of the present general inventive concept will be set forth in part in the description which follows and, in part, will be obvious from the description, or may be learned by practice of the present general inventive concept.

Exemplary embodiments of the present general inventive concept may provide a display apparatus including a display unit to display thereon a two-dimensional (2D) image or a three-dimensional (3D) image, a brightness adjuster to adjust a brightness of an image that is displayed on the display unit, and a controller to control the brightness adjuster to change a maximum brightness of the display unit depending on whether the image displayed on the display unit is the 2D image or the 3D image.

The brightness adjuster may decrease the maximum brightness when the image displayed on the display unit is changed from the 3D image to the 2D image.

The display apparatus may include a storage unit to store therein a first maximum brightness corresponding to the 2D image, and a user input unit to adjust a brightness level of the display unit. The brightness adjuster may adjust a brightness of the display unit corresponding to an adjustment of the brightness level when the image displayed on the display unit is the 2D image and the brightness level is less than the first maximum brightness, and adjust the brightness of the display unit to the first maximum brightness when the brightness level is the first maximum brightness or greater than the first maximum brightness.

The display apparatus may include a storage unit to store therein a second maximum brightness corresponding to the 3D image, and a user input unit to adjust a brightness level of the display unit. The brightness adjuster may adjust a brightness of the display unit corresponding to an adjustment of the brightness level when the image displayed on the display unit is the 3D image and the brightness level is less than the second maximum brightness, and adjust the brightness of the display unit to the second maximum brightness when the brightness level is the second maximum brightness or greater than the second maximum brightness.

The display apparatus may include a backlight unit to supply light to the display unit, and an inverter to drive the backlight unit, and the brightness adjuster may change a frequency applied to the inverter depending on the brightness of the display unit.

The display apparatus may include a user input unit to select whether the image displayed on the display unit is the 2D image or the 3D image.

The display apparatus may include a storage unit to store therein a first maximum brightness corresponding to the 2D image and a second maximum brightness corresponding to the 3D image, and a user input unit to change the first maximum brightness and the second maximum brightness.

Exemplary embodiments of the present general inventive concept may also provide a control method of a display apparatus which includes a display unit to display thereon a two-dimensional (2D) image or a three dimensional (3D) image, the control method including determining whether an image displayed on the display unit is a 2D image or a 3D image, and adjusting a maximum brightness of the display unit depending on whether the image displayed on the display unit is the 2D image or the 3D image.

When the image displayed on the display unit is changed from the 3D image to the 2D image, the maximum brightness may be decreased.

The control method may include receiving an adjustment signal to adjust a brightness level of the display unit, and adjusting a brightness of the display unit corresponding to an adjustment of the brightness level when the image displayed on the display unit is the 2D image and the brightness level is less than a first maximum brightness corresponding to the 2D image, and adjusting a brightness of the display unit to the first maximum brightness when the brightness level is the first maximum brightness or greater than the first maximum brightness.

The control method may include receiving an adjustment signal to adjust a brightness level of the display unit, and adjusting a brightness of the display unit corresponding to an adjustment of the brightness level when the image displayed on the display unit is the 3D image and the brightness level is less than the second maximum brightness corresponding to the 3D image, and adjusting a brightness of the display unit to the second maximum brightness when the brightness level is the second maximum brightness or greater than the second maximum brightness.

The control method may include supplying light to the display unit with a backlight unit, driving the backlight unit with an inverter, and changing a frequency applied to the inverter based on the changed maximum brightness.

The control method may include receiving a selection signal to select whether the image displayed on the display unit is the 2D image or the 3D image.

The control method may include setting a first maximum brightness corresponding to the 2D image and a second maximum brightness corresponding to the 3D image.

Exemplary embodiments of the present general inventive concept may also provide a method of controlling a display of an image on a display apparatus, the method including receiving an image to be displayed with the display apparatus, and adjusting a first maximum brightness of the display apparatus with a controller when the received image is a two-dimensional (2D) image and adjusting a second maximum brightness of the display apparatus with the controller when the received image is a three-dimensional (3D) image.

The method may include that when the received image changes from the 3D image to the 2D image, a maximum brightness of the display apparatus is decreased.

The method may include that the first maximum brightness is less than the second maximum brightness.

Exemplary embodiments of the present general inventive concept may also provide a method of controlling a display apparatus, the method including receiving a selection with the display apparatus to display a two-dimensional (2D) image or a three dimensional (3D) image, and adjusting a first maximum brightness of the display apparatus when the received selection is to display the 2D image, and adjusting a second maximum brightness of the display apparatus when the received selection is to display the 3D image.

The method may also include receiving an adjustment selection to adjust a brightness level of the display apparatus, and adjusting a brightness of the display apparatus according to the received adjustment selection when the image displayed on the display unit is the 3D image and the brightness level is less than the second maximum brightness corresponding to the 3D image, and adjusting a brightness of the display unit to the second maximum brightness when the brightness level is the second maximum brightness or greater than the second maximum brightness.

The method may also include where the first maximum brightness is less than the second maximum brightness.

### BRIEF DESCRIPTION OF THE DRAWINGS

The above and/or other features and utilities will become apparent and more readily appreciated from the following description of the exemplary embodiments, taken in conjunction with the accompanying drawings, in which:

FIG. 1 illustrates a control block diagram of a display apparatus according to exemplary embodiments of the present general inventive concept;

FIG. 2 illustrates a table for brightness levels per image signal that is stored in a storage unit of the display apparatus of FIG. 1 according to exemplary embodiments of the present general inventive concept;

FIG. 3 is a control flowchart illustrating a control method of the display apparatus according to exemplary embodiments of the present general inventive concept;

FIG. 4 is a control block diagram illustrating a display apparatus according to exemplary embodiments of the present general inventive concept;

FIG. 5 is a control flowchart illustrating a control method of the display apparatus of FIG. 4 according to exemplary embodiments of the present general inventive concept; and

FIG. 6 is a control flowchart illustrating a control method of the display apparatus of FIG. 4 according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

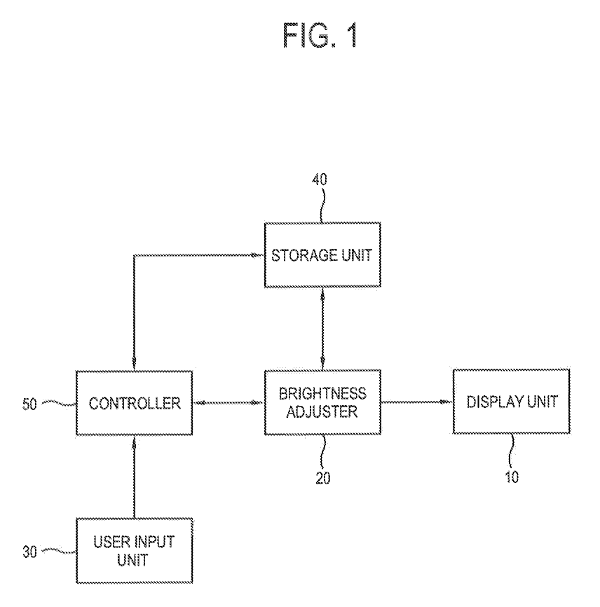

FIG. 1 illustrates a control block diagram of a display apparatus according to exemplary embodiments of the present general inventive concept. The display apparatus according to the exemplary embodiments of the present general inventive concept may receive and display a two-dimensional (2D) image signal, i.e., a plane image signal, or receive and display a three-dimensional (3D) image signal, i.e., a stereoscopic image signal. The display apparatus may include a computer system, a TV, or a portable terminal such as a mobile phone, media player, tablet or pad computer, or other suitable device which displays a broadcasting signal or an image signal input from one or more image sources (e.g., a recording medium, a communications network, etc.) or executes a game application.

As illustrated therein, the display apparatus can include a display unit 10 to display an image thereon, a brightness adjuster 20 to adjust a brightness of the display unit 10, a user input unit 30, a storage unit 40 and a controller 50 to control the foregoing elements. The display apparatus may include a signal receiver, and an image signal/audio signal processor which are not illustrated.

The display unit 10 can display an image thereon based on an image signal processed by the image signal processor (not illustrated). The display unit 10 may include a liquid crystal display (LCD) panel including a liquid crystal layer, an organic light emitting display (OLED) including an organic light emitting layer, or a plasma display panel (PDP). The display unit 10 may include a panel driver to drive the panel. If the display unit 10 includes an LCD panel, the display apparatus may further include a backlight unit to supply light to the LCD panel. Depending on whether an image is a 3D image or 2D image or whether a genre of an image is a movie, a broadcast program, or a game (e.g., a sports game, a video game, etc.), a brightness for the image processing may vary. Accordingly, a brightness of the display unit 10 may be adjusted and vary depending on the type of the image.

The brightness adjuster 20 can adjust a brightness of an image displayed on the display unit 10 according to a control of the controller 50. The brightness adjuster 20 may control the brightness of the display unit 10 by an execution of an application or by a hardware control, and/or a combination thereof.

The user input unit 30 may be a user interface to generate a control signal according to an input received from a user. The user input unit 30 may include a hot key, a mouse, a keyboard, a touch pad, or a touch panel connected to a computer system or a remote controller including a plurality of buttons. A user may adjust the brightness of the display unit 10 within a certain scope, range, and/or increment through the user input unit 30 (e.g., the user input unit 30 may receive an input to gradually adjust the brightness of the display unit 10). For example, a brightness level of the display unit 10 may increase or decrease whenever a user inputs and/or selects a brightness adjustment key of the user input unit 30.

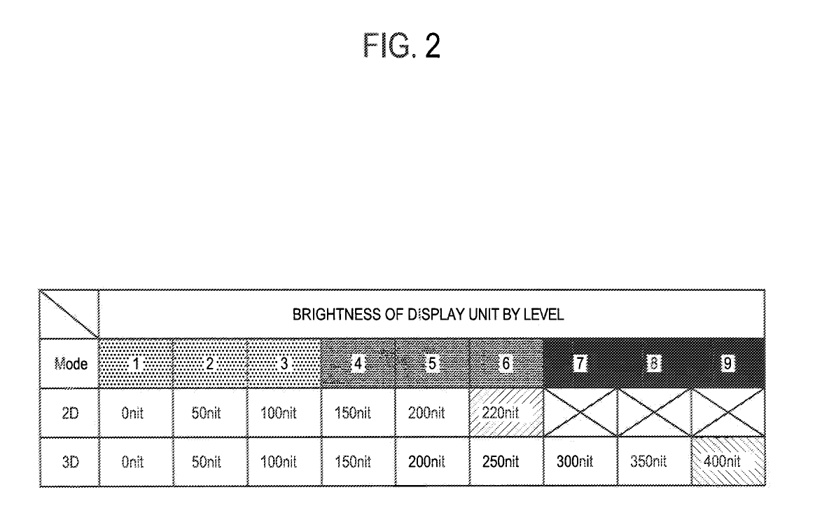

The storage unit 40 can store therein a table including at least a first maximum brightness corresponding to a 2D image, and a second maximum brightness corresponding to a 3D image. FIG. 2 illustrates a table for brightness levels per image signal that can be stored in the storage unit 40. As illustrated therein, a maximum brightness of a 2D image can be 220 nit and a maximum brightness of a 3D image can be 400 nit. A user who views a 2D image may adjust a brightness of the display unit 10 over, for example, a level 1 to a level 6, and may increase the brightness of the display unit 10 up to a level 9 from the level 6 while viewing a 3D image. The 1-10 levels of adjustment are exemplary, and any suitable number of adjustment levels may be used (e.g., 1-20, 1-50, 1-100, 1-1000, etc.).

The table illustrated in FIG. 2 is not fixed, and/or standards of brightness may not be applicable to all display apparatuses. Depending on the size and/or purpose of the display apparatus, the brightness of the display unit 10 may be adjusted differently. That is, the brightness can be increased or decreased according to the type of display. The table may be updated whenever the brightness level is changed.

The controller 50 can control the brightness adjuster 20 to automatically change the maximum brightness of the display unit 10 depending on whether the image displayed on the display unit 10 is a 2D image or a 3D image. That is, if the type of the image is changed (e.g., from a 2-D image to a 3-D image, or from a 3-D image to a 2-D image), the maximum brightness which may be adjusted by a user is changed. As the first maximum brightness corresponding to a 2D image (e.g., 220 nit) is lower than the second maximum brightness corresponding to a 3D image (e.g., 400 nit), the controller 50 can control the brightness adjuster 20 to decrease the maximum brightness when the image displayed on the display unit 10 is changed from a 3D image to a 2D image.

When the maximum brightness of the display unit 10 is the same regardless of the type of displayed images, a user may view an image at a predetermined brightness for a 3D image, even though a 2D image is actually displayed. As the brightness may not adjusted by a user and power may be wasted. A conventional display apparatus includes a physical button to select the number of light sources to thereby adjust the brightness of the display unit 10 depending on the type of images. Typically, additional hardware may be used to select the light sources, which results in a complicated design of the display apparatus and increases manufacturing costs.

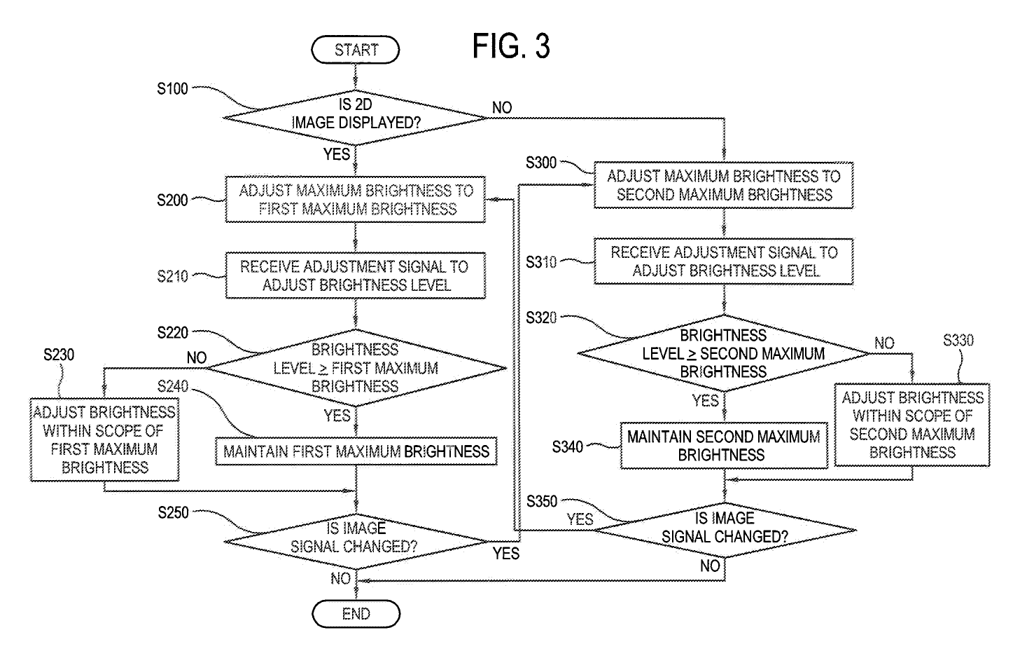

FIG. 3 is a control flowchart illustrating a control method of the display apparatus according to exemplary embodiments of the present general inventive concept. A method of adjusting the brightness by the controller 50 according to exemplary embodiments of the present general inventive concept will be described with reference to FIG. 3.

The controller 50 can determine whether the displayed image is a 2D image at operation S100.

When it is determined that the displayed image is the 2D image, the controller 50 can control the brightness adjuster 20 to automatically adjust the maximum brightness of the display unit 10 to the first maximum brightness at operation S200. As described above, the first maximum brightness may have a lower value than the second maximum brightness corresponding to the 3D image.

Upon receiving an adjustment signal to adjust the brightness level from a user at operation S210, the brightness adjuster 20 can determine whether the brightness level is the first maximum brightness or whether the brightness level is greater than the first maximum brightness at operation S220.

When it is determined that the brightness level is less than (i.e., below) the first maximum brightness, the brightness adjuster 20 can adjust the brightness of the display unit within the scope of the first maximum brightness corresponding to the adjustment of the brightness level at operation S230. That is, the brightness adjuster 20 can adjust the brightness level to the first maximum brightness level (e.g., 220 nit), or to a level that is less than the first maximum brightness level (e.g., less than 220 nit), according to an adjustment amount.

When the brightness level is greater than or equal to the first maximum brightness, the brightness adjuster 20 can adjust the brightness of the display unit 10 to the first maximum brightness at operation S240. That is, even when a user inputs a command to increase the brightness level through the user input unit 30, the brightness adjuster 20 may maintain the first maximum brightness. According to such control, when the 2D image is displayed following the 3D image, the brightness of the display unit 10 which a user may adjust can be limited to the first maximum brightness (e.g., 220 nit) from the second maximum brightness (e.g., 400 nit), and unnecessary power consumption may be minimized and/or prevented.

When an image signal is changed when the 2D image is displayed at operation S250, i.e., the 3D image is displayed on the display unit 10, and the controller 50 controls the brightness adjuster 20 to automatically adjust the maximum brightness of the display unit 10 to the second maximum brightness at operation S300.

Similar to displaying the 2D image, when the adjustment signal is received from a user to adjust the brightness level at operation S310, the brightness adjuster 20 can determine whether the brightness level is the second maximum brightness or more at operation S320.

When it is determined that the brightness level is below the second maximum brightness, the brightness adjuster 20 can adjust the brightness of the display unit 10 within the scope of the second maximum brightness corresponding to the adjustment of the brightness level at operation S330, and can adjust the brightness of the display unit 10 to the second maximum brightness when the brightness level is the second maximum brightness or when the brightness level is greater than the second maximum brightness at operation S340. When the 3D image with an increased brightness is viewed following the 2D image, a user may increase the brightness of the display unit 10 by using the user input unit 30. According to exemplary embodiments of the present general inventive concept, the second maximum brightness (e.g., 400 nit) may be greater than the first maximum brightness (e.g., 220 nit), and a user may adjust the brightness level as, for example, 3 levels.

When the 3D image is changed to the 2D image at operation S350, the operation S200 can be performed.

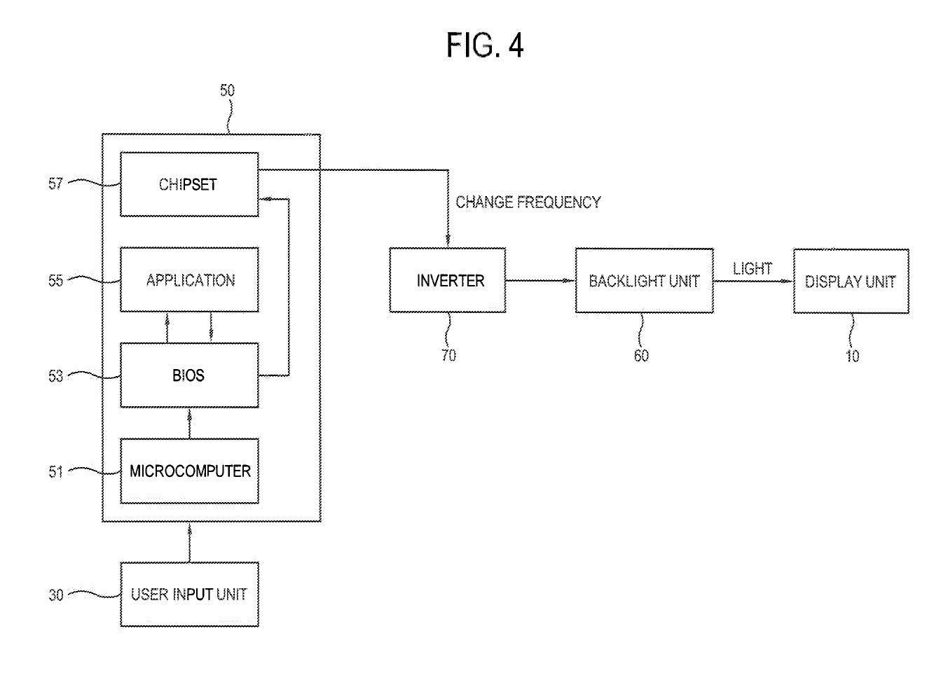

FIG. 4 is a control block diagram illustrating a display apparatus according to exemplary embodiments of the present general inventive concept.

As illustrated therein, the display apparatus can include a backlight unit 60 to supply light to a display unit 10, and an inverter 70 to drive the backlight unit 60. The display unit 10 can include a liquid crystal display (LCD) panel (not illustrated), and can display an image by receiving light from the backlight unit 60. A controller 50 can include a microcomputer 51, a BIOS 53 (e.g., a Basic Input Output System integrated circuit), an application 55 (e.g., the application may be stored in a memory device such as a solid state memory, a hard disk drive, and/or a solid state drive), and a chipset 57.

A user input unit 30 can receive a selection signal to select whether an image displayed on the display unit 10 is a 2D image or a 3D image. A user may provide information of a displayed image (e.g., whether the image is a 2D image or a 3D image) to the controller 50, and the controller 50 can control a brightness of the display unit 10 based on the selection signal received from the user input unit 30 (e.g., an input selection by a user).

According exemplary embodiments of the present general inventive concept, the controller 50 may determine the type of the image (e.g., whether the image is a 2D image or a 3D image) without receiving a selection signal from the user input unit (e.g., without a selection from a user). For example, the controller 50 may determine the type of the image depending on whether a sync signal is generated when a 3D image is displayed or by a specific algorithm used for processing only a 3D image.

The microcomputer 51 can receive a user's input signal through the user input unit 30, and can transmit the user's input signal to the BIOS 53. The microcomputer 51 may be a control block which supplies power to the user input unit 30 and may determine whether a user's input signal is generated.

Upon receiving a signal with respect to the type of the image, the BIOS 53 can output the information of the type of the signal (e.g., whether the image is a 2D image or a 3D image) to the application 55 that is executed on the basis of the OS (i.e., operating system), and the application 55 can adjust a maximum brightness of the display unit 10.

The application 55 can be computer executable code (e.g., software) which is an interface for a user to control the display apparatus. That is, the application 55 may provide a user interface to receive input to control the display apparatus. The application 55 according to exemplary embodiments of the present general inventive concept may include a battery management program which manages a battery supplying auxiliary power to the display apparatus. The application 55 can include information of a table for the brightness level per images, and can be coded to vary the maximum brightness depending on the type of the image.

The application 55 can set the maximum brightness depending on the currently displayed image (e.g., whether the image is a 2D image or a 3D image), and can transmit to the BIOS 53 the information of the brightness level that is adjusted within the scope of the maximum brightness. That is, the application 55 can set and/or adjust the maximum brightness according to whether the displayed image is a 2D image or a 3D image.

The BIOS 53 can transmit to the chipset 57 the information of the brightness level from the application 55, and the chipset 57 can adjust a PWM (pulse width modulation) frequency output to the inverter 70. If the PWM frequency increases, brightness of light emitted from the backlight unit 60 can accordingly increase. If the PWM frequency decreases, the brightness of light emitted by the backlight unit 60 can accordingly decrease. The chipset 57 may change the brightness of light emitted by the backlight unit 60 by changing a duty ratio of the PWM signal.

The transmitting of the signal by the application 55, the BIOS 53, and the chipset 57 is according to exemplary embodiments of the present general inventive concept, and the present invention is not limited thereto, and may be improved or changed by the skilled in the art.

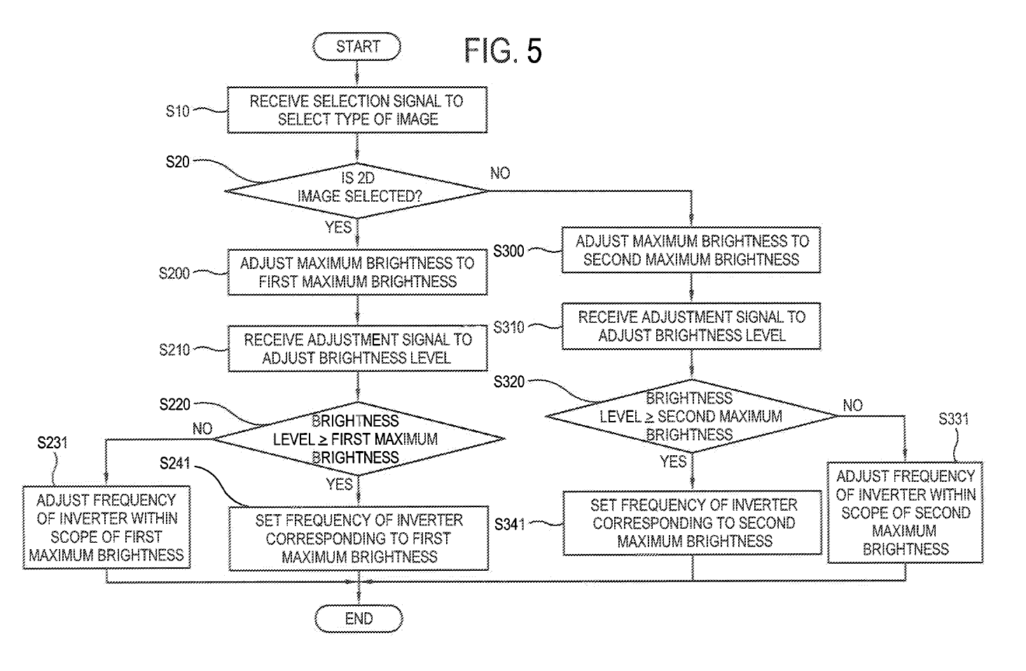

FIG. 5 is a control flowchart illustrating a control method of the display apparatus according to exemplary embodiments of the present general inventive concept. The brightness adjustment by the inverter 70 will be described with reference to FIG. 5.

A selection signal can be received from the user input unit 30 to select the type of the image at operation 510.

The information of the type of the image can be transmitted to the application 55 through the BIOS 53, and the maximum brightness can be set based on the table of the application 55.

When it is determined that the selected image is a 2D image at operation S20, the maximum brightness can be adjusted to a first maximum brightness at operation S200. When it is determined that the selected image is the 3D image at operation S20, the maximum brightness can adjusted to a second maximum brightness at operation S300.

Upon receiving the adjustment signal from a user to adjust the brightness level at operations S210 and S310, it is determined whether the desired brightness level is the maximum brightness or more at operations S220 and S320 as described above in connection with operations S220 and S320 in FIG. 3.

When it is determined that the brightness level adjusted by a user is below the first or second maximum brightness, the chipset 57 can set the frequency of the PWM signal applied to the inverter 70 within the scope of the first or second brightness corresponding to the adjustment of the brightness level at operations S231 and S331.

When the brightness level is the first or second maximum brightness, or greater than the first or second maximum brightness, the chipset 57 can adjust the frequency of the PWM signal applied to the inverter 70 to the value corresponding to the first or second maximum brightness to thereby maintain the brightness of the display unit 10 at the first or second maximum brightness at operations S241 and S341.

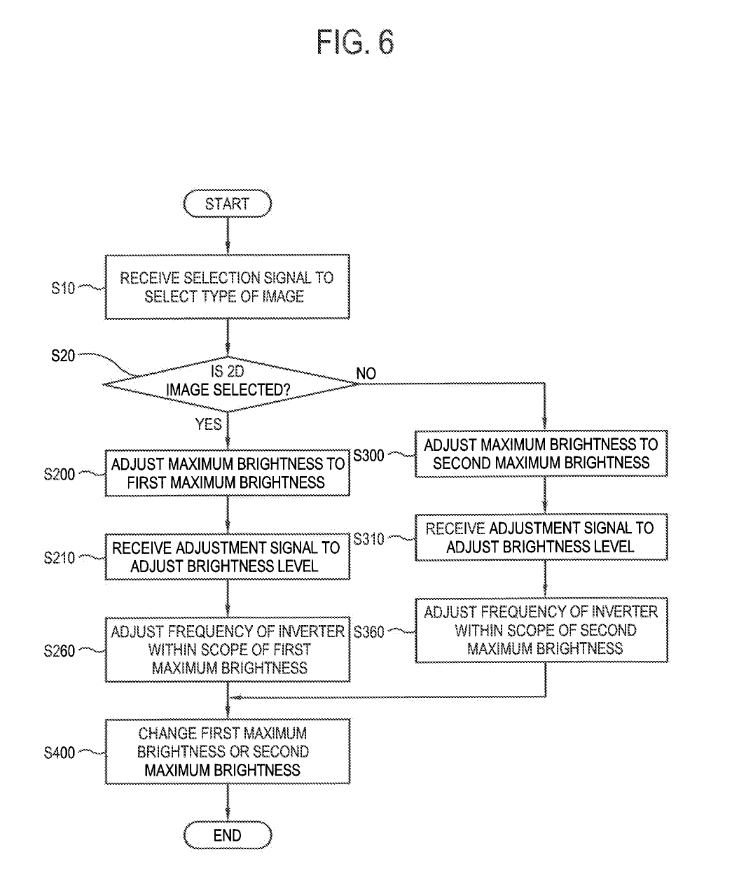

FIG. 6 is a control flowchart illustrating a control method of the display apparatus according to exemplary embodiments of the present general inventive concept.

As illustrated therein, the operations of receiving the selection signal to select the type of the image, of setting the maximum brightness according to the selected image and of adjusting the frequency of the inverter 70 are substantially similar to the operations S10, S20, S200, S210, S231, S241, S310, S320, S331, and S341 described above at least in connection with FIG. 5.

The control method of the display apparatus according to exemplary embodiments of the present general inventive concept illustrated in FIG. 6 includes an operation of changing a first maximum brightness corresponding to a 2D image and a second maximum brightness corresponding to a 3D image at operation S400. That is, a user may change or newly set through the user input unit 30 the first and second maximum brightness values of the table stored as illustrated in FIG. 2. Alternatively, a user may adjust an interval of the brightness levels, or divide the levels and add new levels. That is, the user may divide the present brightness levels and add new levels so as to increase the number of brightness levels.

The exemplary embodiments of the present general inventive concept may save power consumption of the display unit 10 by automatically adjusting the maximum brightness level depending on the type of the image displayed on the display unit 10, and can provide an interface to control the brightness by a user. That is, power consumption by the display unit 10 may be decreased by adjusting the maximum brightness level according to whether the image to be displayed is a 2D image or a 3D image.

As described above, a display apparatus and a control method of the same according to exemplary embodiments of the present general inventive concept automatically controls different maximum brightness depending on a type of an image and consumes less power.

A display apparatus and a control method of the same according to exemplary embodiments of the present general inventive concept can set a maximum brightness depending on a type of an image.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although several exemplary embodiments have been illustrated and described, it will be appreciated by those skilled in the art that changes may be made in these exemplary embodiments without departing from the principles and spirit of the invention, the range of which is defined in the appended claims and their equivalents.

What is claimed is:

1. A display apparatus comprising:
a display unit to display thereon a two-dimensional (2D) image or a three-dimensional (3D) image;
a brightness adjuster to adjust a brightness of an image that is displayed on the display unit; and
a controller to control the brightness adjuster to change a maximum brightness of the display unit depending on whether the image displayed on the display unit is the 2D image or the 3D image.

2. The display apparatus according to claim 1, wherein the brightness adjuster decreases the maximum brightness when the image displayed on the display unit is changed from the 3D image to the 2D image.

3. The display apparatus according to claim 1, further comprising:
a storage unit to store therein a first maximum brightness corresponding to the 2D image, and a user input unit to adjust a brightness level of the display unit,
wherein the brightness adjuster adjusts a brightness of the display unit corresponding to an adjustment of the brightness level when the image displayed on the display unit is the 2D image and the brightness level is less than the first maximum brightness, and adjusts the brightness of the display unit to the first maximum brightness when the brightness level is the first maximum brightness or greater than the first maximum brightness.

4. The display apparatus according to claim 1, further comprising:
a storage unit to store therein a second maximum brightness corresponding to the 3D image, and a user input unit to adjust a brightness level of the display unit,
wherein the brightness adjuster adjusts a brightness of the display unit corresponding to an adjustment of the brightness level when the image displayed on the display unit is the 3D image and the brightness level is less than the second maximum brightness, and adjusts the brightness of the display unit to the second maximum brightness when the brightness level is the second maximum brightness or greater than the second maximum brightness.

5. The display apparatus according to claim 1, further comprising:
a backlight unit to supply light to the display unit, and an inverter to drive the backlight unit,
wherein the brightness adjuster changes a frequency applied to the inverter depending on the brightness of the display unit.

6. The display apparatus according to claim 1, further comprising:
a user input unit to select whether the image displayed on the display unit is the 2D image or the 3D image.

7. The display apparatus according to claim 1, further comprising:
a storage unit to store therein a first maximum brightness corresponding to the 2D image and a second maximum brightness corresponding to the 3D image, and a user input unit to change the first maximum brightness and the second maximum brightness.

8. A control method of a display apparatus which comprises a display unit to display thereon a two-dimensional (2D) image or a three-dimensional (3D) image, the control method comprising:
determining whether an image displayed on the display unit is a 2D image or a 3D image; and
adjusting a maximum brightness of the display unit depending on whether the image displayed on the display unit is the 2D image or the 3D image.

9. The control method according to claim 8, wherein when the image displayed on the display unit is changed from the 3D image to the 2D image, the maximum brightness is decreased.

10. The control method according to claim 8, further comprising:
receiving an adjustment signal to adjust a brightness level of the display unit; and
adjusting a brightness of the display unit corresponding to an adjustment of the brightness level when the image displayed on the display unit is the 2D image and the brightness level is less than a first maximum brightness corresponding to the 2D image, and adjusting a brightness of the display unit to the first maximum brightness when the brightness level is the first maximum brightness or greater than the first maximum brightness.

11. The control method according to claim 8, further comprising:
receiving an adjustment signal to adjust a brightness level of the display unit; and
adjusting a brightness of the display unit corresponding to an adjustment of the brightness level when the image displayed on the display unit is the 3D image and the brightness level is less than the second maximum brightness corresponding to the 3D image, and adjusting a brightness of the display unit to the second maximum brightness when the brightness level is the second maximum brightness or greater than the second maximum brightness.

12. The control method according to claim 8, further comprising:
supplying light to the display unit with a backlight unit,
driving the backlight unit with an inverter; and
changing a frequency applied to the inverter based on the changed maximum brightness.

13. The control method according to claim 8, further comprising:
receiving a selection signal to select whether the image displayed on the display unit is the 2D image or the 3D image.

14. The control method according to claim 8, further comprising:
setting a first maximum brightness corresponding to the 2D image and a second maximum brightness corresponding to the 3D image.

15. A method of controlling a display of an image on a display apparatus, the method comprising:
receiving an image to be displayed with the display apparatus; and
adjusting a first maximum brightness of the display apparatus with a controller when the received image is a two-dimensional (2D) image and adjusting a second maximum brightness of the display apparatus with the controller when the received image is a three-dimensional (3D) image.

16. The method of claim 15, further comprising:
when the received image changes from the 3D image to the 2D image, a maximum brightness of the display apparatus is decreased.

17. The method of claim 15, wherein the first maximum brightness is less than the second maximum brightness.

18. A method of controlling a display apparatus, the method comprising:
receiving a selection with the display apparatus to display a two-dimensional (2D) image or a three dimensional (3D) image; and
adjusting a first maximum brightness of the display apparatus when the received selection is to display the 2D image, and adjusting a second maximum brightness of the display apparatus when the received selection is to display the 3D image.

19. The method of claim 18, further comprising:
receiving an adjustment selection to adjust a brightness level of the display apparatus; and
adjusting a brightness of the display apparatus according to the received adjustment selection when the image displayed on the display unit is the 3D image and the brightness level is less than the second maximum brightness corresponding to the 3D image, and adjusting a brightness of the display unit to the second maximum brightness when the brightness level is the second maximum brightness or greater than the second maximum brightness.

20. The method of claim 18, wherein the first maximum brightness is less than the second maximum brightness.
